(19) United States
(12) Patent Application Publication
(10) Pub. No.: US 2025/0080445 A1
(43) Pub. Date: Mar. 6, 2025

(54) MONITORING DEVICE, MONITORING METHOD, AND MONITORING PROGRAM

(71) Applicant: NIPPON TELEGRAPH AND TELEPHONE CORPORATION, Tokyo (JP)

(72) Inventors: Yuki TAKEI, Tokyo (JP); Satoshi NAKATSUKASA, Tokyo (JP); Masato NISHIGUCHI, Tokyo (JP); Hiroyuki ONISHI, Tokyo (JP)

(73) Assignee: NIPPON TELEGRAPH AND TELEPHONE CORPORATION, Tokyo (JP)

(21) Appl. No.: 18/681,026

(22) PCT Filed: Aug. 6, 2021
(86) PCT No.: PCT/JP2021/029422

§ 371 Date: Feb. 2, 2024

(51) Int. Cl. H04L 43/10; H04L 43/02

(52) U.S. Cl. CPC H04L 43/10; H04L 43/02

(57) ABSTRACT

A monitoring device (10) sets a first node (20A) that is a node on a transmission side that switches a route of a packet in user communication to copy the packet in the user communication, enable an INT setting, and transmit the copied packet to each of routes that are switching destination candidates based on an instruction input from a maintenance person. In addition, the monitoring device (10) sets a second node (20B) that is a node on a reception side that accommodates the routes that are switching destination candidates to collect INT information of the copied packet and discard the copied packet. Thereafter, the monitoring device (10) acquires the INT information of the copied packet from the second node (20B) and visualizes communication quality of each of the routes that are the switching destination candidates in the user communication based on the acquired INT information.

### TECHNICAL FIELD

The present invention relates to a monitoring device, a monitoring method, and a monitoring program.

### BACKGROUND ART

In-band network telemetry (INT) is a technique of monitoring the communication quality of a network. INT is a technology in which a device on a packet transmission side adds time stamp information, loss information, or the like as metadata to a packet for transmission, a device on a packet reception side acquires the metadata added to the packet, and thereby the state of the network is monitored in real time in detail.

### CITATION LIST

### Non Patent Literature

NPL 1: “In-band Network Telemetry (INT) Dataplane Specification Version 2.1”, P4. org., [retrieved on Jul. 14, 2021], Internet <https://github.com/p4lang/p4-applications/blob/master/docs/INT_v2_1.pdf>

### SUMMARY OF INVENTION

### Technical Problem

However, since INT is a technique of acquiring communication quality information of a route through which packets to be monitored actually pass, the communication quality information of a plurality of different routes cannot be acquired under the same conditions (e.g., the same time, the same number of sessions, the same band, and the like). For this reason, there is a problem that, when a delay or communication failure occurs on a certain route, the communication quality of a route that is a switching destination candidate cannot be quantitatively evaluated, and an appropriate route cannot necessarily be selected. Therefore, the present invention aims to solve the above-described problem and to quantitatively evaluate the communication quality of a route that is a switching destination candidate.

### Solution to Problem

In order to solve the above-described problem, the present invention includes a first setting part that sets a first node that is a node on a transmission side that switches a route of a packet in user communication to copy the packet in the user communication, enable an INT setting, and transmit the copied packet to each of routes that are switching destination candidates, a second setting part that sets a second node that is a node on a reception side that accommodates the routes that are switching destination candidates to collect INT information of the copied packet and discard the copied packet, and an INT information acquisition part that acquires the INT information of the copied packet from the second node.

### Advantageous Effects of Invention

According to the present invention, the communication quality of a route that is a switching destination candidate can be quantitatively evaluated.

### BRIEF DESCRIPTION OF DRAWINGS

FIG. 1 is a diagram for describing an overview of an operation of a monitoring device.

FIG. 2 is a diagram for describing an overview of an operation of the monitoring device.

FIG. 3 is a diagram illustrating an example of a processing procedure when the monitoring device stops an INT process.

FIG. 4 is a diagram illustrating a configuration example of a monitoring device.

FIG. 5 is a diagram showing an example of a processing procedure when the monitoring device performs evaluation after switching a route.

FIG. 6 is a diagram for describing user identification information.

FIG. 7 is a diagram for describing a monitoring device according to another embodiment.

FIG. 8 is a diagram illustrating a configuration example of a computer that executes a monitoring program.

### DESCRIPTION OF EMBODIMENTS

Modes (embodiments) for carrying out the present invention will be described below with reference to the drawings. The present invention is not limited to the embodiments described below.

### Overview

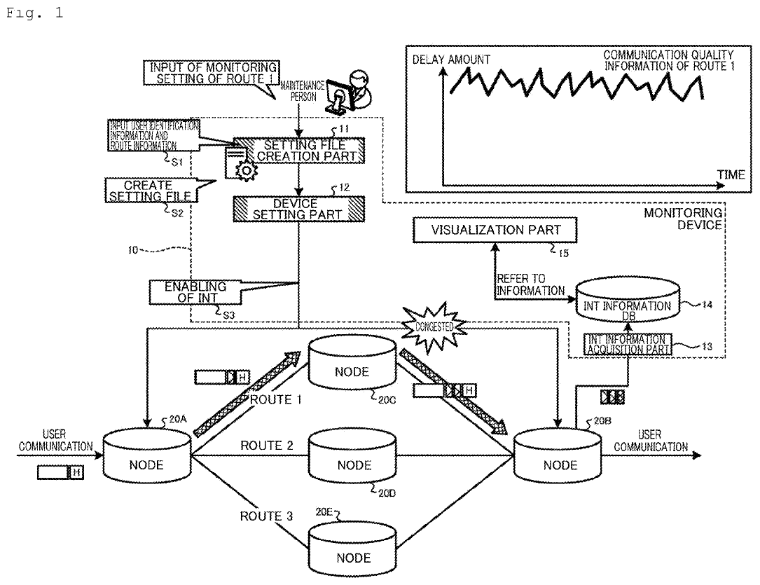

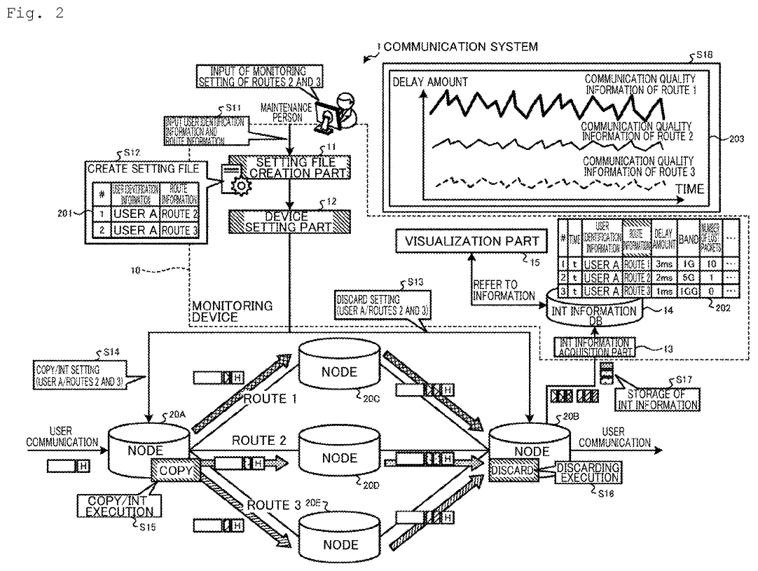

First, an overview of a monitoring device 10 according to the present embodiment will be described with reference to FIGS. 1 and 2. Here, a case in which a monitoring device 10 uses INT to monitor a route 1 and then monitor routes 2 and 3 will be described as an example.

Nodes 20 (nodes 20A to 20E) are nodes for transferring packets in user communication. A case in which the node 20A among the nodes is a node on a transmission side in user communication to be monitored and the node 20B is a node on a reception side in the user communication will be described as an example.

First, a maintenance person inputs monitoring settings of the route 1 to the monitoring device 10. For example, the maintenance person inputs identification information (user identification information) of user communication to be monitored and route information of the route 1 to the monitoring device 10 (S1 in FIG. 1). Then, a setting file creation part 11 of the monitoring device 10 creates a setting file of each node 20 (for example, nodes 20A and 20B) on the route 1 based on the input information (S2) to enable INT (S3).

Thus, for example, when transferring a packet on the route 1, the node 20A on the packet transmission side in the user communication to be monitored adds metadata of INT (INT information) to the packet and transfers the packet. Each time a packet with INT information added thereto is transferred, the node ID, the time stamp information, packet loss information, or the like of the node 20 through which the pad has passed are recorded in the INT information. In addition, when the node 20B on the packet reception side in the user communication to be monitored receives the packet in the user communication from the route 1, the node 20B transmits the INT information added to the packet to the monitoring device 10.

Thereafter, when the monitoring device 10 detects that, for example, the route 1 is significantly delayed (e.g., congested) based on the INT information received from the node 20B, the monitoring device considers switching to the route 2 or the route 3.

Next, a procedure of the monitoring device 10 acquiring INT information of the route 2 and the route 3, which are switching route candidates, will be described with reference to FIG. 2.

First, a maintenance person inputs monitoring settings of the route 2 and the route 3 to the monitoring device 10. For example, the maintenance person inputs user identification information and route information of the route 2 and the route 3 to the monitoring device 10 (S11).

Then, the setting file creation part 11 of the monitoring device 10 creates a setting file of each node 20 based on the input information (S12).

For example, the setting file creation part 11 creates a setting file in which identification information (user identification information) of user communication to be monitored is associated with route information of the user communication, as indicated by reference numeral 201.

Then, a device setting part 12 sets the node 20B to discard the packet based on the setting file (S13). For example, the device setting part 12 sets the node 20B to discard the packet of a user A received from the route 2 and the route 3.

The device setting part 12 also sets the node 20A for packet copy/INT based on the setting file (S14). For example, the device setting part 12 sets the node 20A to copy the packet of the user A, execute INT, and transmit the packet to the route 2 and the route 3.

Based on these settings, the node 20A copies the packet of the user A and executes INT (S15: copy/INT execution). For example, the node 20A copies the packet of the user A, adds INT information thereto, and transmits the packet to the route 2 and the route 3.

Thereafter, the node 20B discards the packet (copied packet) of the user A received from the route 2 and the route 3 (S16). For example, the node 20B extracts the INT information of the route 2 and the route 3 added to the header of the copied packet and then discards the packet. Thereafter, the node 20B transmits the INT information extracted from the copied packet to the monitoring device 10.

An INT information acquisition part 13 of the monitoring device 10 stores the INT information (refer to reference numeral 202) transmitted from the node 20B in an INT information DB 14 (S17). Thereafter, a visualization part 15 creates communication quality information (refer to reference numeral 203) of each of the routes 1, 2, and 3 based on the INT information stored in the INT information DB 14 (S18).

Thus, the maintenance person can quantitatively compare the communication quality of the respective routes (the route 2 and the route 3) that are switching destination candidates for the route 1. As a result, the maintenance person can consider whether the route should be switched to the route 2 or the route 3, or which of the route 2 and the route 3 is better if the route needs to be switched.

### Configuration Example of Monitoring Device

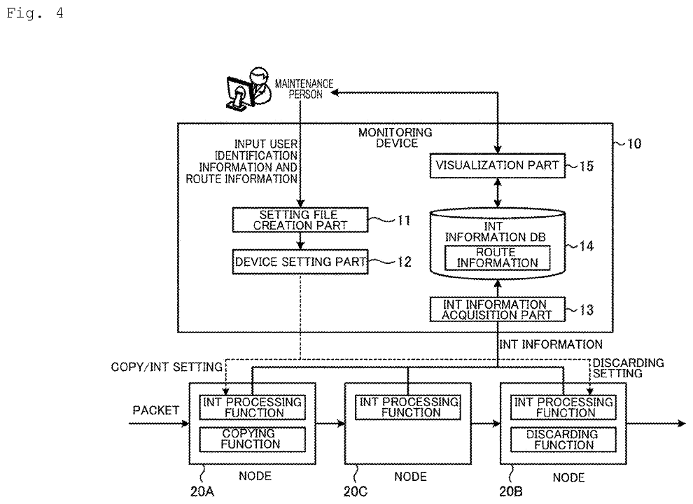

Next, a configuration example of the monitoring device 10 will be described with reference to FIG. 4. The monitoring device 10 includes the setting file creation part 11, the device setting part (a first setting part and a second setting part) 12, the INT information acquisition part 13, the INT information DB 14, and the visualization part 15.

The setting file creation part 11 creates a setting file of each node 20 based on information input by the user (for example, a maintenance person) of the monitoring device 10.

For example, the setting file creation part 11 creates a setting file (refer to reference numeral 201 in FIG. 2) in which identification information (e.g., user identification information) of user communication to be monitored is associated with route information of the user communication based on information input by the maintenance person.

The route information included in the setting file may be, for example, information in which an order of the nodes 20 through which data needs to pass for each route is represented by their node IDs or the like, or may be information representing policy information used for traffic engineering.

In addition, upon receiving a monitoring stop instruction from a user (e.g., the maintenance person) of the monitoring device 10, the setting file creation part 11 creates a monitoring stop file of each node 20 based on the instruction.

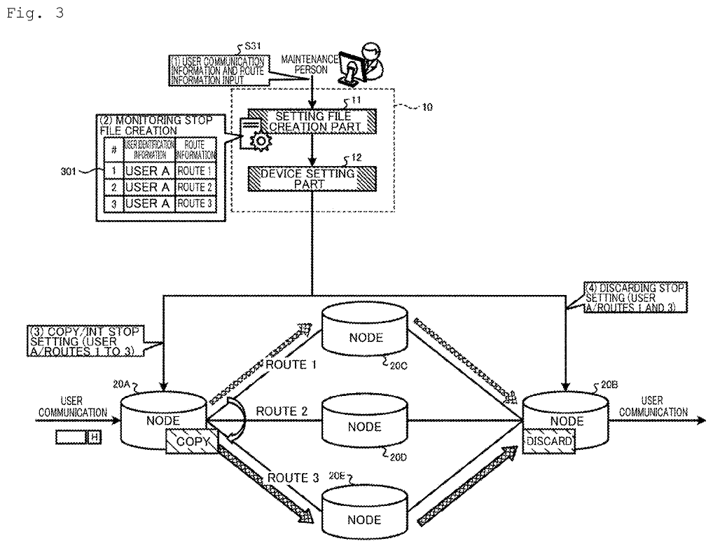

For example, (1) upon receiving input of identification information (user identification information) of the user communication whose monitoring needs be stopped and route information, the setting file creation part 11 (2) creates a monitoring stop file as illustrated in FIG. 3. For example, the setting file creation part 11 creates a monitoring stop file in which the user identification information of the user communication whose monitoring needs to be stopped is associated with the route information of the user communication, as indicated by reference numeral 301.

Description will return to FIG. 4. The device setting part 12 makes a setting for each node 20 on the route to be monitored based on the setting file created by the setting file creation part 11.

For example, the device setting part 12 sets the node 20A on the route on the packet transmission side in the user communication to be monitored to copy the packet in the user communication, enable INT settings, and transmit the copied packet to each of the routes to be monitored (routes that are switching destination candidates) based on the setting file.

In addition, the device setting part 12 sets the node 20B on the route on the packet reception side in the user communication to be monitored to collect the INT information of the copied packet and discard the copied packet based on the setting file.

In addition, the device setting part 12 sets each node 20 on the route to be monitored for a monitoring stop based on the monitoring stop file created by the setting file creation part 11.

For example, the device setting part 12 sets the node 20A on the route on the packet transmission side in the user communication to be monitored to stop copying of the packet of the user A and stop INT of the routes 1 to 3 based on the monitoring stop file indicated by reference numeral 301 in FIG. 3 ((3) of FIG. 3). In addition, the device setting part 12 sets the node 20B on the route on the packet reception side in the user communication to be monitored to stop discarding the copied packet of the user A based on the monitoring stop file indicated by reference numeral 301 in FIG. 3 ((4) of FIG. 3).

Description will return to FIG. 4. The INT information acquisition part 13 acquires INT information of a packet in user communication to be monitored from a node 20. For example, the INT information acquisition part 13 acquires INT information from the node 20B on the packet reception side in user communication to be monitored.

The INT information DB 14 stores the INT information acquired by the INT information acquisition part 13. The INT information stored in the INT information DB 14 may be the INT information added to the packet or processed INT information. When the INT information stored in the INT information DB 14 is processed, for example, the INT information stored in the INT information DB 14 includes the time of the user communication, identification information (user identification information) of the user communication, route information of the user communication, the delay amount, the band, the number of lost packets, and the like on the route of the route information obtained from the INT information as indicated by reference numeral 202 in FIG. 2.

Description returns to FIG. 4. The visualization part 15 visualizes the communication quality of each route based on the INT information stored in the INT information DB 14. For example, the visualization part 15 creates information (communication quality information) displaying the communication quality of each of the routes 1 to 3 based on the INT information of the routes 1 to 3 stored in the INT information DB 14 (refer to reference numeral 203 in FIG. 2). Then, the visualization part 15 displays the created information on, for example, a display device (not illustrated).

This configuration enables the user of the monitoring device 10 (e.g., a network maintenance person) to quantitatively evaluate the communication quality of the routes that are switching destination candidates.

### [Node]

The nodes 20 are realized by, for example, general routers. The nodes 20 have, for example, not only a packet transfer function but also a packet copy function, an INT processing function, a packet discarding function, and the like.

For example, the node 20A on the packet transmission side in the user communication copies the packet in the user communication to be monitored with the packet copy function based on the settings by the monitoring device 10. Furthermore, the node 20A adds INT information to each packet in the user communication to be monitored with the INT processing function. Thereafter, the node 20A transmits the copied packets to the next node 20 on the monitoring route (a switching route candidate) set by the monitoring device 10.

In addition, upon receiving the packet with the INT information added thereto, for example, the node 20C that relays packets of user communication adds identification information, time stamp information, or the like of the node 20 itself to the INT information using the INT processing function and transfers the information to the next node 20.

In addition, for example, the node 20B on the packet reception side in the user communication collects the INT information added to the received packets using the INT processing function based on the settings from the monitoring device 10. Thereafter, the node 20B discards the copied packet among the received packets using the packet discarding function. The node 20B determines whether the received packets are copied packets based on, for example, the IF that has received the packets. For example, the node 20B determines a packet received from the IF of a route to be monitored (a switching route candidate) set by the monitoring device 10 as a copied packet.

Furthermore, the following method may be adopted as a method for determining a copied packet. For example, the node 20A on the packet transmission side in user communication edits header information of a packet when copying the packet. Then, upon receiving the packet, the node 20B may determine whether the packet is a copied packet by referring to the header information of the packet.

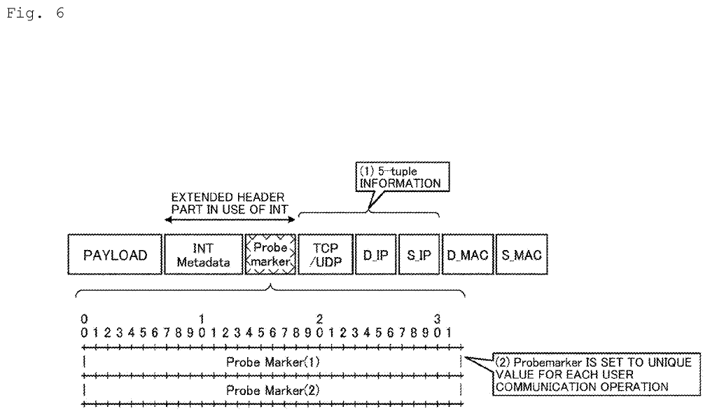

In addition, the node 20 identifies the user of the packet based on the user identification information included in the received packet. For example, the user identification information may use (1) 5-tuple information of the packet, or (2) Probemaker as illustrated in FIG. 6. When (2) Probemaker is used, for example, the node sets Probemaker to a unique value for each user communication operation.

### [Evaluation After Switching]

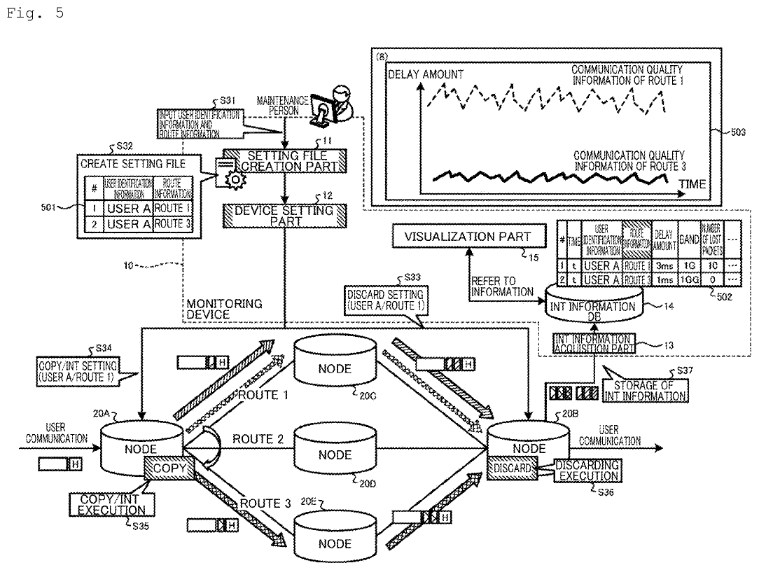

The monitoring device 10 may transmit the copied packets again and evaluate the degree to which the communication quality is improved after switching the route. The processing procedure of this case will be described with reference to FIG. 5. Here, a case in which the monitoring device 10 evaluates the communication quality of the route 1 before switching and the route 3 after switching will be described as an example.

First, a maintenance person inputs identification information (user identification information) of user communication, and route information of the route 1 and the route 3 to the monitoring device 10 (S31).

Then, the setting file creation part 11 of the monitoring device 10 creates a setting file of each node 20 based on the input information (S32). For example, the setting file creation part 11 creates a setting file indicated by reference numeral 501.

Then, the device setting part 12 sets the node 20B to discard a packet based on the created setting file (S33). For example, the device setting part 12 sets the node 20B to discard the packet of a user A received from the route 1.

In addition, the device setting part 12 also sets the node 20A for packet copy/INT based on the setting file (S34). For example, the device setting part 12 sets the node 20A to copy the packet of the user A, add INT information thereto, and transmit the packet to the route 1.

The node 20 A copies the packet of the user A and adds the INT information thereto based on the setting (S35: execution of copy/INT). For example, the node 20A copies the packet of the user A, adds the INT information thereto, and transmits the packet to the route 1. Furthermore, the node 20A adds the INT information to the packet of the user A and transmits the packet to the route 3.

Thereafter, the node 20B discards the packet (copied packet) of the user A received from the route 1 (S36). For example, the node 20B extracts the INT information added to the header of the copied packet received from the route 1 and then discards the packet. In addition, the node 20B extracts the INT information added to the header of the packet of the user A received from the route 3.

Thereafter, the node 20B transmits the extracted INT information of the route 1 and route 3 to the monitoring device 10. The INT information acquisition part 13 of the monitoring device 10 stores the INT information (refer to reference numeral 502) transmitted from the node 20B (S37). Then, the visualization part 15 creates communication quality information (refer to reference numeral 503) of each of the route 1 and route 3 as indicated by reference numeral 503.

According to the monitoring device 10 described above, the user can confirm how much the communication quality has been improved by performing route switching from the route 1 to the route 3.

### OTHER EMBODIMENTS

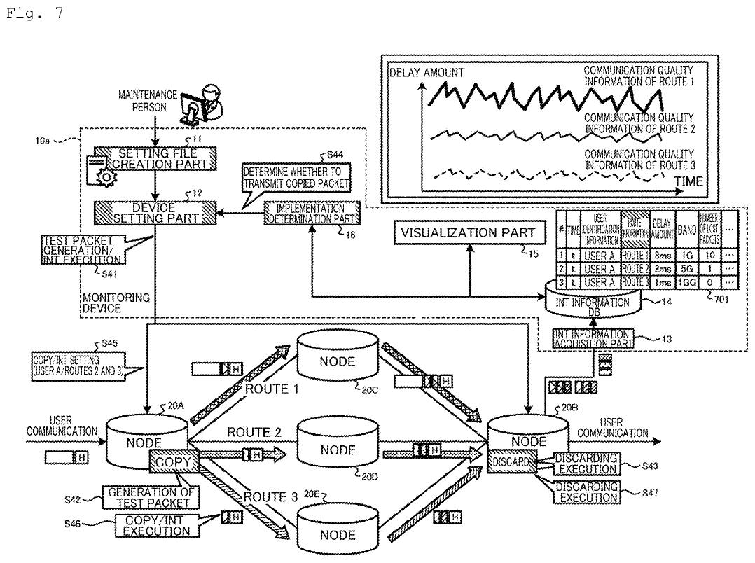

When the monitoring device 10 suddenly transmits a copied packet to the switching route candidate, there is a possibility that the transmission may affect other communication operation on the switching route candidate. Therefore, the monitoring device 10 may cause the node 20 to transmit a test packet to the switching route candidate and determine whether to transmit a copied packet to the route based on the communication quality of the route obtained from the test packet. The monitoring device 10 in this case will be described as a monitoring device 10a. The monitoring device 10a will be described with reference to FIG. 7.

The monitoring device 10a further includes an implementation determination part 16. The implementation determination part 16 determines whether to transmit a copied packet to the route based on INT information of the switching route candidate obtained from the test packet.

An exemplary processing procedure of the monitoring device 10a will be described. Here, a case in which the monitoring device 10a transmits a test packet to the routes 2 and 3 that are switching candidates will be described as an example.

First, the device setting part 12 of the monitoring device 10 sets the nodes 20A and 20B to perform generation/INT of a test packet (S41). For example, the node 20A generates a test packet with INT information added thereto (S42) and transmits the packet from the route 2 and the route 3 based on the setting.

The test packet is, for example, uses header information of a packet in user communication or uses a part of the packet.

After S42, upon receiving the test packet from the route 2 and the route 3, the node 20B acquires INT information from the test packet and discards the test packet (S43: perform discarding).

Thereafter, the node 20B transmits the INT information extracted from the packet of the routes 2 and 3 to the monitoring device 10. The INT information acquisition part 13 of the monitoring device 10 stores the INT information (refer to reference numeral 701) transmitted from the node 20B in the INT information DB 14.

Thereafter, the implementation determination part 16 refers to the information in the INT information DB 14 to determine whether to transmit a copied packet to the route 2 and the route 3 (S44).

For example, the implementation determination part 16 determines to transmit a copied packet to the route 2 and the route 3 if the communication quality of the route 2 and the route 3 obtained from the INT information DB 14 satisfies predetermined communication quality. On the other hand, if the communication quality of the route 2 and the route 3 does not satisfy the predetermined communication quality, the implementation determination part 16 determines not to transmit a copied packet to the route 2 and the route 3.

Here, when the implementation determination part 16 determines to transmit a copied packet to the route 2 and the route 3, the device setting part 12 sets 20A to perform copy/INT of the packet (S45). For example, the device setting part 12 sets the node 20A to copy the packet of the user A, and transmit the packet to the route 2 and the route 3.

The node 20A copies the packet of the user A and adds the INT information thereto based on the setting (S46: execution of copy/INT). For example, the node 20A copies the packet of the user A, adds the INT information thereto, and transmits the packet to the route 2 and the route 3.

Thereafter, the node 20B discards the packet (copied packet) of the user A received from the route 2 and the route 3 (S47). For example, the node 20B extracts the INT information added to the header of the copied packet and then discards the packet.

With this configuration, the monitoring device 10a can confirm the communication quality of the switching route candidates with the test packet and then determine to transmit the copied packet.

### [System Configuration, Etc.]

In addition, each constituent element of each illustrated part is functionally conceptual and need not necessarily be physically configured as illustrated in the drawings. In other words, the specific forms of dispersion and integration of each device are not limited to those illustrated in the drawings, and all of or a part of the device may be functionally or physically distributed or integrated in any unit depending on various loads, usage conditions, or the like. Furthermore, all or any part of each processing function performed by each device can be realized by a CPU and a program executed by the CPU, or can be realized as hardware based on wired logic.

In addition, all or some of the steps of the processing described as being automatically performed out of the steps of the processing described in the foregoing embodiment may also be manually performed, or all or some of the steps of the processing described as being manually performed may also be automatically performed using a known method. In addition, the processing procedure, the control procedure, specific names, information including various types of data and parameters that are shown in the above document and drawings may be arbitrarily changed unless otherwise specified.

### [Program]

The above-described monitoring device 10 can be implemented by installing a program (monitoring program) as package software or on-line software in a desired computer. For example, by causing an information processing device to execute the program, the information processing device can be caused to function as the monitoring device 10. The information processing device mentioned here includes a mobile communication terminal such as a smartphone, a mobile telephone, and a personal handyphone system (PHS), and further, a terminal such as a personal digital assistant (PDA) is included in that category.

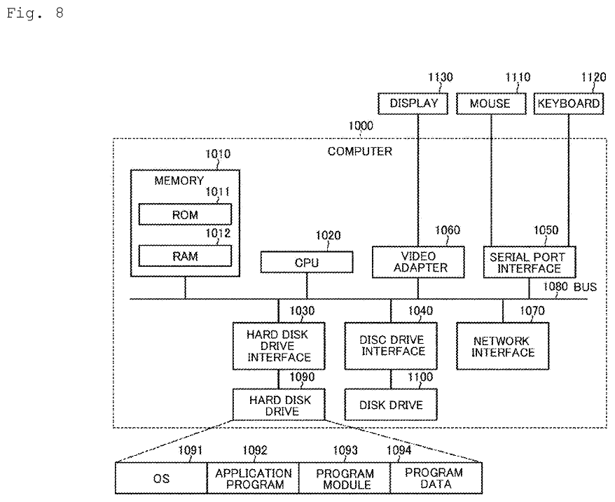

FIG. 8 is a diagram illustrating an example of a computer that executes a monitoring program. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. These units are connected to one another via a bus 1080.

The memory 1010 includes a read only memory (ROM) 1011 and a random access memory (RAM) 1012. The ROM 1011 stores a boot program, for example, a basic input output system (BIOS), or the like. The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. A video adapter 1060 is connected to, for example, a display 1130.

The hard disk drive 1090 stores, for example, an OS 1091, an application program 1092, a program module 1093, and program data 1094. That is, a program defining each processing operation executed by the above-described monitoring device 10 is mounted as a program module 1093 in which codes that can be executed by a computer are described. The program module 1093 is stored in, for example, the hard disk drive 1090. For example, the program module 1093 executing similar processing to the functional configuration of the monitoring device 10 is stored in the hard disk drive 1090. The hard disk drive 1090 may be replaced with a solid-state drive (SSD).

In addition, data used for the processing of the above-described embodiment is stored, for example, as program data 1094 in the memory 1010 or the hard disk drive 1090. In addition, the CPU 1020 reads the program module 1093 or the program data 1094 stored in the memory 1010 or the hard disk drive 1090 onto the RAM 1012 and executes it as necessary.

The program module 1093 or the program data 1094 is not limited to being stored in the hard disk drive 1090 and may also be stored in, for example, a removable storage medium and may be read by the CPU 1020 via the disk drive 1100 or the like. Alternatively, the program module 1093 or the program data 1094 may be stored in another computer connected via a network (a local area network (LAN), a wide area network (WAN), or the like). In addition, the program module 1093 and the program data 1094 may be read by the CPU 1020 from the other computer via the network interface 1070.

### REFERENCE SIGNS LIST

10, 10a Monitoring device
11 Setting file creation part
12 Device setting part (first setting part and second setting part)
13 INT information acquisition part
14 INT information DB
15 Visualization part
16 Implementation determining part
20 (20A, 20B, 20C, 20D, 20E) Node

1. A monitoring device comprising:
processing circuitry configured to
set a first node that is a node on a transmission side that switches a route of a packet in user communication to copy the packet in the user communication, enable an INT setting, and transmit the copied packet to each of routes that are switching destination candidates;
set a second node that is a node on a reception side that accommodates the routes that are switching destination candidates to collect INT information of the copied packet and discard the copied packet; and
acquire the INT information of the copied packet from the second node.

2. The monitoring device according to claim 1, further comprising:
processing circuitry configured to
visualize communication quality of each of the routes that are the switching destination candidates in the user communication based on the acquired INT information.

3. A monitoring method executed by a monitoring device, the monitoring method comprising:
setting a first node that is a node on a transmission side that switches a route of a packet in user communication to copy the packet in the user communication, enable an INT setting, and transmit the copied packet to each of routes that are switching destination candidates;
setting a second node that is a node on a reception side that accommodates the routes that are switching destination candidates to collect INT information of the copied packet and discard the copied packet; and
acquiring the INT information of the copied packet from the second node.

4. A monitoring program causing a computer to execute:
setting a first node that is a node on a transmission side that switches a route of a packet in user communication to copy the packet in the user communication, enable an INT setting, and transmit the copied packet to each of routes that are switching destination candidates;
setting a second node that is a node on a reception side that accommodates the routes that are switching destination candidates to collect INT information of the copied packet and discard the copied packet; and
acquiring the INT information of the copied packet from the second node.
